(19) United States
(12) Patent Application Publication
(10) Pub. No.: US 2011/0041224 A1
(43) Pub. Date: Feb. 17, 2011

(54) ATOMIC FORCE MICROSCOPE INCLUDING ACCELEROMETER

(75) Inventors: Arvind Raman, West Lafayette, IN (US); Ronald G. Reifenberger, West Lafayette, IN (US); John T. Melcher, West Lafayette, IN (US)

Correspondence Address: BINGHAM MCHALE LLP, 2700 MARKET TOWER, 10 WEST MARKET STREET, INDIANAPOLIS, IN, 46204-4900, US

(73) Assignee: PURDUE RESEARCH FOUNDATION, West Lafayette, IN (US)

(21) Appl. No.: 12/852,095

(22) Filed: Aug. 6, 2010

Related U.S. Application Data
(60) Provisional application No. 61/231,778, filed on Aug. 6, 2009.

(51) Int. Cl. G01Q 60/24

(52) U.S. Cl. 850/40

(57) ABSTRACT

A microcantilever used in Atomic Force Microscopy (AFM) includes an elongated cantilevered body with a probe tip placed preferably near its free end and preferably along the cantilever's axis. Some embodiments of the present invention integrate into the microcantilever body an embedded or etched paddle that rotates rigidly about an axis parallel to that of the cantilever with hinges that connect the paddle to the cantilever body. In one embodiment the resonance frequency of this paddle resonator is higher than the fundamental resonance of the microcantilever so that the paddle rotation is proportional to the vertical microcantilever acceleration at the hinge location. The motion of the paddle can be detected using radiation irradiating the paddle; the reflected beam is centered onto a four quadrant photodiode as commonly found in AFM. The paddle's vertical motion is detected in the usual way by monitoring the vertical channel in the photodiode while its rotation is monitored from the lateral channel in the photodiode. By monitoring the vertical tip acceleration signal from the paddle rotation, it is possible to resolve the history of tip-sample force during oscillation cycles. A calibration method to convert the measured paddle rotation into vertical probe tip acceleration and instantaneous tip-sample force is also disclosed.

### CROSS REFERENCE TO RELATED APPLICATION

This application claims the benefit of priority to U.S. Provisional Patent Application Ser. No. 61/231,778, filed Aug. 6, 2009, incorporated herein by reference.

### FIELD OF THE INVENTION

The various embodiments of the present invention pertain to various methods and apparatus used for determining properties on the surface of a sample, and in particular to dynamic atomic force microscopy (dAFM) that includes an acceleration measurement. Yet other embodiments pertain more generally to methods and apparatus for measurement of acceleration, and in particular methods and apparatus using a structure supported as a cantilever.

### BACKGROUND OF THE INVENTION

Dynamic AFM (dAFM) variously known as tapping, intermittent contact, non contact, amplitude or frequency modulation AFM, is a means to image the nanoscale topography of a sample with a vibrating microcantilever by keeping the amplitude, and/or phase, and/or frequency shift of the cantilever constant during a scan. dAFM, including amplitude modulated or tapping mode AFM, is now one of the foremost AFM tools used for nanoscale resolution imaging and compositional contrast with gentle forces of a wide variety of material surfaces under vacuum, ambient or liquid environments. In amplitude modulated AFM (or AM-AFM) a microcantilever with a sharp tip is driven harmonically near the resonance of a specific eigenmode and brought closer to the sample. As a consequence of the short and long range interactions between the surface atoms on the sample and tip, the tip oscillation amplitude is carefully adjusted to a user determined setpoint amplitude. The setpoint amplitude is held constant by means of a feedback controller that adjusts the height of the cantilever while scanning the sample, thus rendering topography images of the sample.

In AM-AFM, the observables, that is, those quantities that can be measured directly from the photodetector in an AFM, are (a) the tip oscillation waveform, (b) the tip amplitude at the drive frequency, (c) its phase relative to the driving signal and (d) any higher harmonics with their corresponding amplitudes and phases. One hidden quantity in AM-AFM is the tip-sample interaction force. The process of relating the observables to the hidden tip-sample interaction forces is called force spectroscopy. In turn, knowledge of tip-sample interaction forces allows the quantitative measurement of local electric charge, van der Waals forces, specific chemical forces, dissipation, elasticity, adhesion, hydrophilicity or hydrophobicity with nanometer resolution on the sample surface, thus improving dAFM's as an analytical tool. Force spectroscopy in AM-AFM can also reveal the peak tip-sample interaction force in a given cycle of oscillation. These peak interaction forces are useful to AFM experimentalists because they are the imaging forces exerted onto the sample and are minimized including when scanning fragile biological samples. Imaging forces of the order of even a few nanonewtons can irreversibly deform the macromolecule being imaged.

Existing methods for force spectroscopy in AM-AFM can be grouped into two categories depending on the type of data processing involved: (a) Frequency domain methods which use the outputs of lock-in amplifiers, that is the amplitudes and phases of the drive and/or their higher harmonics or (b) time-domain methods such as SPAM (scanning probe acceleration microscopy) which analyze the time domain signals. However these methods cannot provide time-resolved tip-sample interaction forces in real time because of post-processing of data or the acquisition of many signals at points on the sample.

In order to measure tip-sample forces in “real time”, rather than back out tip-sample force from the cantilever vibration data, the cantilever should be instrumented with an additional sensor whose output is proportional to the tip-sample force with minimal post-processing needs. In some designs such a sensor was made out of two interdigitated fingers embedded in the cantilever, and the relative motion between them was sensed by optical interferometry. This sensor was placed near the tip and its resonance frequency rendered high so that its output could be correlated to tip-sample force. However such cantilevers may use an additional detector (an optical interferometer for measuring the relative motion of the interdigitated fingers) to measure the force which can make such systems expensive. Furthermore, an alignment procedure is often helpful.

Eccentric tip cantilevers have been proposed as a path forward to tip-sample force reconstruction by monitoring the torsion signal as the cantilever taps on the surface. In such torsional harmonic cantilevers the cantilever is T-shaped consisting of the main long body and a shorter cross bar. The cantilever is anchored at the base of the long main body. The tip is fabricated on the far end of the cross bar. As the tip taps on the sample, the cantilever twists due to the asymmetry of the force with respect to the cantilever axis. The twisting motion can be detected by the four quadrant photodetector which is used in commercial AFMs. This technology does may not require an additional detector for the tip-sample forces and simply uses a channel available within some AFM systems (torsion signal) to monitor the tip-sample forces. The cantilever is designed so its torsional frequency is much higher than the frequency at which the cantilever is driven so that the twisting angle is directly proportional to the measured tip-sample force.

Some aspects of torsion harmonic cantilever technology include the following. First, offsetting the tip from the cantilever axis unbalances the mass center which can couple the bending and torsion modes and leads to cross talk between the vertical and lateral deflection channels of the photodetector. Second, the force sensor used is essentially the torsional mode of the cantilever which is spatially extended across the cantilever. Thus, its modal mass tends to be high and in order to make its resonance frequency high, the torsional stiffness also should be high, thus reducing the sensitivity. To increase force sensitivity in spite of high torsional stiffness the tip may be offset further from the axis. Third, the torsion harmonic cantilevers change the traditional cantilever design and the introduction of a cross bar and offset tip can change the fundamental bending mode properties. Finally, the force sensor in the torsion cantilevers may participate in interactions between the tip and sample. This causes the sensor dynamics to couple with the AFM probe dynamics. The force sensor or accelerometer should be a non-intrusive device that has a minimal effect on original AFM probe design and minimal effect on the nature with which the AFM probe interacts with the sample. To this end, the sensor should be (a) low mass, (b) minimally affect the mass distribution of the original cantilever, and (c) one whose mass and stiffness can be optimized locally without requiring global changes to the cantilever design.

Various improvements in the methods and apparatus for fabricating and using cantilever probes and atomic force microscopes are described in the drawings, text, and claims that follow.

### SUMMARY OF THE INVENTION

One aspect of the present invention pertains to an apparatus for scanning a sample with a microscope. Some embodiments include a cantilever beam having two opposing ends, one end being fixed and the other end being free. Yet other embodiments include a tip affixed to the beam, the tip being adapted and configured for interacting with the sample, the beam and the tip being symmetrical about a plane. Still other embodiments include a paddle coupled to the beam by two hinges defining an axis, the paddle being bendable relative to the beam about the axis. The paddle has a center of mass; wherein at least one of the center of mass or the hinge axis is laterally offset from the plane.

Another aspect of the present invention pertains to a method for scanning the surface of a sample. Some embodiments include providing a cantilevered probe having a tip and a sensor that provides a response to acceleration of the probe. Other embodiments include driving the probe in bending at a frequency. Still other embodiments include moving the probe toward the surface and interacting the tip with the surface, accelerating the probe, and measuring the response of the sensor during acceleration.

Yet another aspect of the present invention pertains to a method for modifying a probe for scanning a sample with an atomic force microscope. Some embodiments include providing a probe assembly useful for microscopy, the assembly including a cantilevered structural member with a tip. Yet other embodiments include cutting a paddle through the structural member and hinging the paddle to the structural member.

Another aspect of the present invention pertains to an apparatus for taking measurements on an object. Some embodiments include a cantilever beam having two opposing ends, one end being fixed to the object and the other end being free, the beam being rotatable in a first direction about the fixed end. Yet other embodiments include a tip extending from the beam, the tip being adapted and configured for interacting with the object or the environment of the object. Yet other embodiments include a paddle coupled to the beam by at least one flexible hinge and rotatable relative to the beam in a second direction about the hinge, the second direction being substantially orthogonal to the first direction, wherein the beam has a planar surface from the free end to the fixed end, and movement of the paddle about the hinge is substantially normal to the planar surface.

Another aspect of the present invention pertains to a method for calibrating a cantilevered probe of a microscope. The method in some embodiments includes providing a first cantilevered probe that supports a member in cantilever manner, the first probe having a first end and a second end. The method includes measuring the flexural response of the first probe. Yet other embodiments of the method include supporting the first probe by the second end with the first end being free to move. The method includes vibrating the supported first probe at the fundamental resonance mode of the first probe. The method in some embodiments includes measuring the bending response of the cantilevered member during said vibrating. Yet other embodiments of the method include correcting the bending response by the flexural response and determining the acceleration of the fee end of the first probe.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

FIG. 1(a) is a schematic representation of an atomic force microscope according to one embodiment of the present invention.

FIG. 1(b) is a schematic representation according to one embodiment of the present invention of a rotational paddle accelerometer cantilever. In this embodiment two torsional hinges connect the paddle to the main cantilever body. In general the paddle center of mass (COM) and the hinge axis can be offset from the cantilever axis.

FIGS. 2(a)-2(g) are schematic representations of various paddle accelerometer configurations according to other embodiments of the present invention.

FIGS. 3(a)-3(d) are photographic representations of examples of AFM microcantilevers with paddle accelerometers according to other embodiments of the present invention fabricated using focused ion beam milling of an existing commercial cantilever.

FIGS. 4(a) and 4(b) are pictorial representations of the eigenmodes of the cantilever shown in FIG. 3(c).

FIG. 5(a) is a schematic diagram shown to identify some dimensions of a hinged paddle according to one embodiment of the present invention.

FIG. 5(b) is a schematic diagram of a side view of the hinge of the apparatus of FIG. 5(a) in which the rotational angle Θ is identified as well as the torsional spring constant Kₕ.

FIG. 5(c) is a plot diagram shown of the gain of the transfer function (paddle rotation/base acceleration) of the apparatus of FIG. 5(a) showing the rotational gain (in rads-s²/m) as a function of the drive frequency ω.

FIG. 6 is a schematic representation of vertical tip motion time history and tip acceleration history for typical cantilevers tapping on samples in air.

FIGS. 7(a)-7(c) shows existing AFM designs: (a) shows the torsion harmonic cantilever of U.S. Pat. Nos. 7,404,314; 7,302,833; and 7,089,787, which uses T-shaped cantilevers with offset tips to measure tip-sample forces, and (b) and (c) hinged cantilevers described in U.S. Pat. No. 7,533,561.

FIG. 8 includes graphical and pictorial representations of paddle rotational angle and cantilever tip acceleration as a function of frequency.

FIGS. 9(a) and 9(b) are schematic representations of a probe assembly according to one embodiment of the present invention, the probe not interacting with the surface of the sample

FIGS. 10(a) and 10(b) are schematic representations of the probe of FIG. 9 interacting with the surface of a sample.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

One aspect of some embodiments of the present inventions includes a rotational paddle accelerometer embedded in a microcantilever that is useful in the measurement of time-resolved tip-sample forces commonly encountered in the practice of Atomic Force Microscopy. A microcantilever has embedded or etched in it a paddle that rotates rigidly about an axis with hinges that connect the paddle to the microcantilever body. While such a device will find general use in the atomic force microscope community, it will also find application in the remote sensing and measurement of the acceleration in any small object to which a microcantilever might be appended.

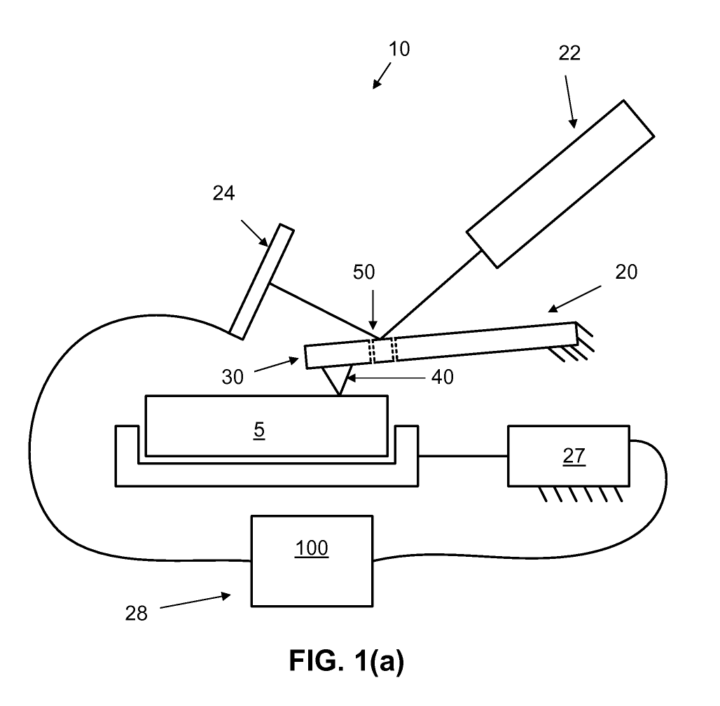

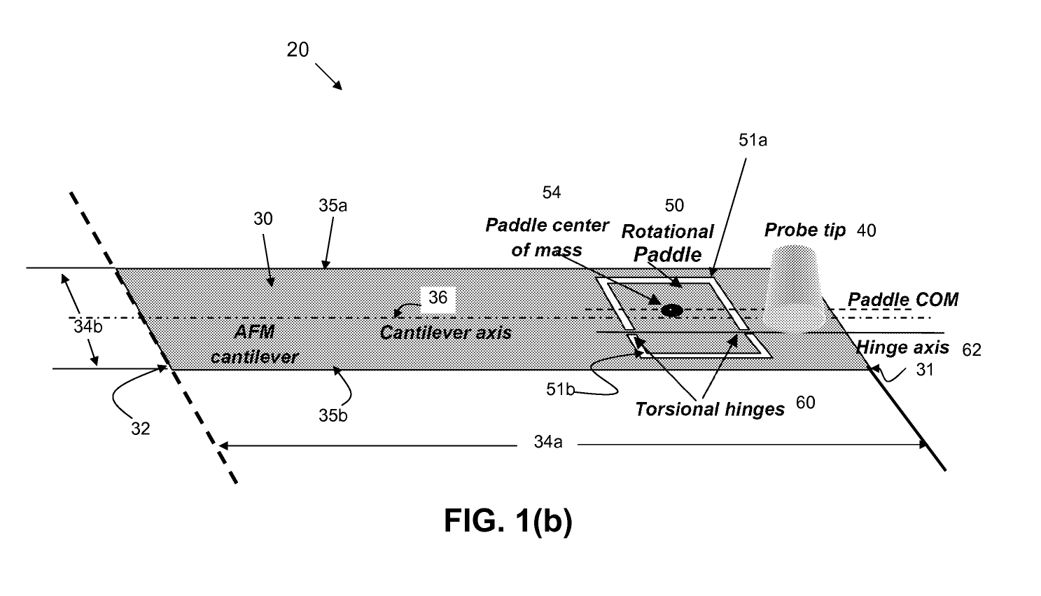

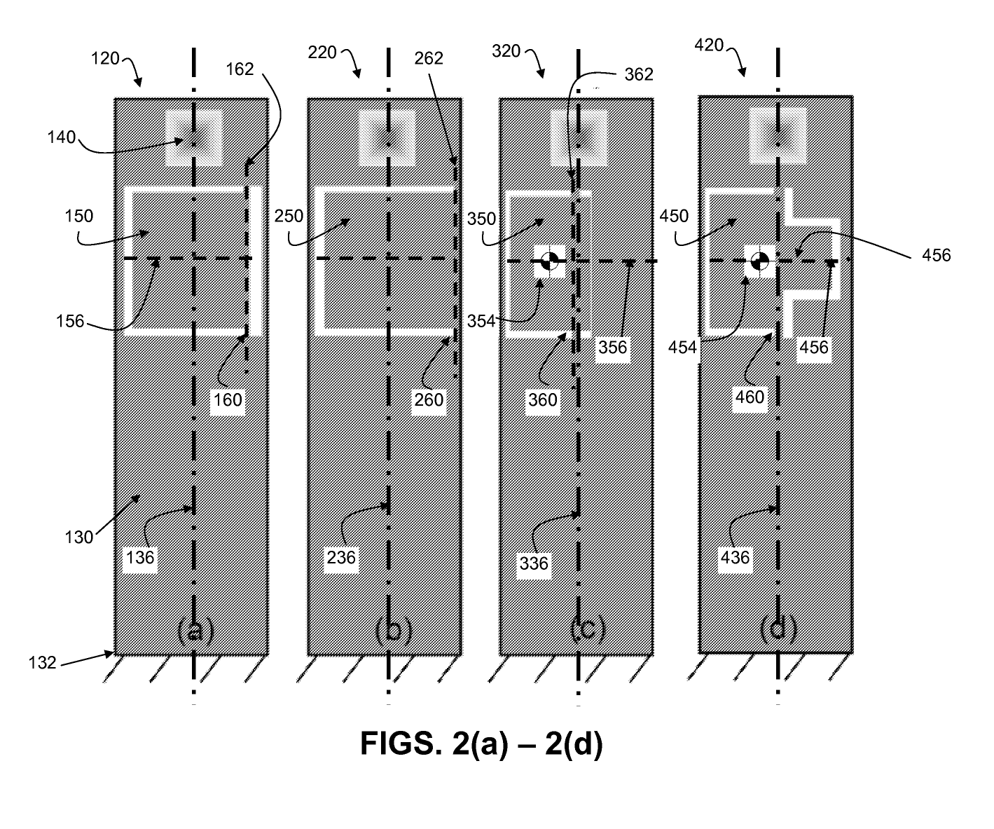

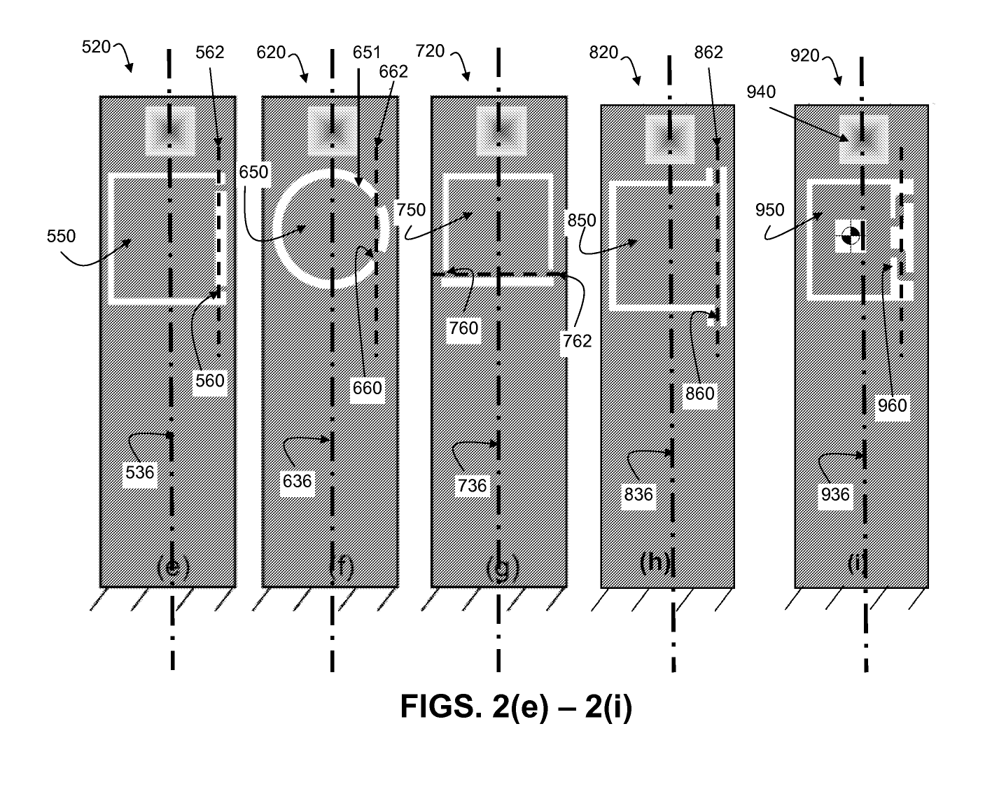

One aspect of some embodiments provides an alternate means to measure time resolved tip-sample interaction forces in dAFM rapidly while scanning an image in the tapping mode (or any dAFM mode). Preferably, a paddle shaped structure 50 is fabricated which is coupled to the main cantilever body 20 by soft hinges 60. The hinges can be torsional as shown in FIG. 1 or flexural as shown in FIG. 2 or could be folded beams as shown in FIG. 2i. The paddle center of mass (COM) 54 and the hinge axis can both be offset from the main cantilever axis. The hinge axis is preferably parallel to the length 34a of the cantilever so that the paddle rotates in a direction orthogonal to cantilever bending. The paddle oscillator can have its resonance frequency much higher than the fundamental bending mode of the cantilever. As a result the paddle rotation angle is generally proportional to the vertical cantilever acceleration at the hinges (especially for acceleration frequency components that lie below the resonance of the paddle resonator). Thus by monitoring the rotational motion of the paddle, it is possible to know or infer the vertical acceleration of the cantilever. The product of this acceleration with the effective modal mass of the cantilever yields directly the history of forces in real time acting on the cantilever, including the sharp pulses when the tip taps on the sample.

Some aspects of certain embodiments of the present invention are as follows. It is understood that none of the aspects described herein are required in any particular embodiment of the present invention, and that various embodiments can include any combination of the aspects described herein.

When a laser 22 is focused on the paddle 50, then the vertical motion of the cantilever is detected in the vertical channel of the photodetector 26 which receives the reflected laser beam. The rotational motion of the paddle can simply be detected using the lateral channel of the photodetector, this channel being readily available in some commercial AFM systems. Thus by using an extra available channel it is possible to read out the tip acceleration in real time as the tip scans across the sample.

The paddle accelerometer slightly perturbs the mass symmetry of the cantilever 30, i.e. the mass on either side of the cantilever axis is slightly different. It also causes minimal stiffness asymmetry since the accelerometer is usually located towards the end of the cantilever where little cantilever bending occurs. Thus (a) the presence of the paddle accelerometer slightly influences the properties of the fundamental cantilever mode allowing this design to be integrated into existing cantilever designs, and (b) the minimal asymmetry of mass introduced by the accelerometer minimizes unwanted coupling between torsion and bending cantilever modes.

Some aspects of the accelerometer, i.e. its gain and bandwidth, can be adjusted/designed locally and may not require a modification of the remainder of the cantilever.

The design of the paddle accelerometer can take into account that its stiffness may be dominated by the hinges 60 while its effective mass may be generally dictated by the paddle mass and inertia. Thus one can adjust the hinge geometry rather than modifying the entire paddle to adjust the paddle stiffness.

The overall cantilever shape remains unchanged in some embodiments—the rotational accelerometer is simply embedded inside the overall shape. The various configurations of paddles and hinges contemplated herein are adaptable to a wide variety of existing cantilever probe shapes, including as examples, those that are rectangular or triangular.

Some embodiments of the present invention pertain to a cantilever probe in which modifications are made to an existing cantilever design. Examples of cantilever probes that can be modified to include accelerometers and paddles as shown herein include those made by Nansurf, Asylum Research, Nanoworld, Nanotools, MikroMasch, Olympus, Vico, Nanosensors, and Smarttip. The hinged cantilever design is generally compatible with many different configurations of AFMs

The mass production of some paddle cantilevers can be accomplished using standard Si processing techniques familiar to those working in the semiconductor industry. In some embodiments, the accelerometer or paddle is fabricated using a focused ion beam to cut through the existing cantilever. In yet other embodiments, the paddle can be introduced during the fabrication cycle by means of photolithography.

While semiconductor processing techniques enable mass production, slight variations in dimension from cantilever to cantilever may occur that can lead to uncertainties in the operational calibration constants. As an example, in careful work, it requires about 1 h of effort to calibrate the spring constant of a conventional cantilever. On the other hand, the design of a hinged cantilever according to some embodiments of the present invention allows for a self-calibration procedure using simple techniques.

The stiffness of the paddle accelerometer can be determined by the hinge stiffness while its rotational inertia can be determined by the shape of the paddle and the location of its hinges. Some embodiments use torsional hinges while others use bending hinges. Still other embodiments use hinges that are in a combination of torsion and bending. In one embodiment, the resonance frequency of the paddle resonator is tuned to an integer multiple of the fundamental for highly sensitive mapping of variations of local mechanical and chemical properties of the sample. In one embodiment the paddle is placed near the vibration node of the second or higher eigenmodes to suppress their contributions to the measured acceleration.

Various embodiments of the present invention contemplate a wide variety of torsional and flexural hinges supporting various paddle shapes in cantilevered manner. Referring to FIG. 2: (a) shows a generic paddle accelerometer with torsional hinges where the paddle rotation is proportional to vertical acceleration at the hinges; (b) shows an example when the moment arm for rotation is maximized and the torsional hinges are on one side of the cantilever; (c) shows a design where the torsional hinges are along the cantilever axis so that the accelerometer measures vertical acceleration at the cantilever axis; (d) shows a design wherein if the paddle size in (d) is too small for a laser spot, then an asymmetric extension of the paddle area on the other side of the hinge axis is possible; (e) shows an example where flexural hinges are used instead of torsional hinges; (f) shows an example where the hinges undergo both flexure and some torsion; and (g) shows an example where the axis of rotation is not aligned with the axis of the longitudinal cantilever.

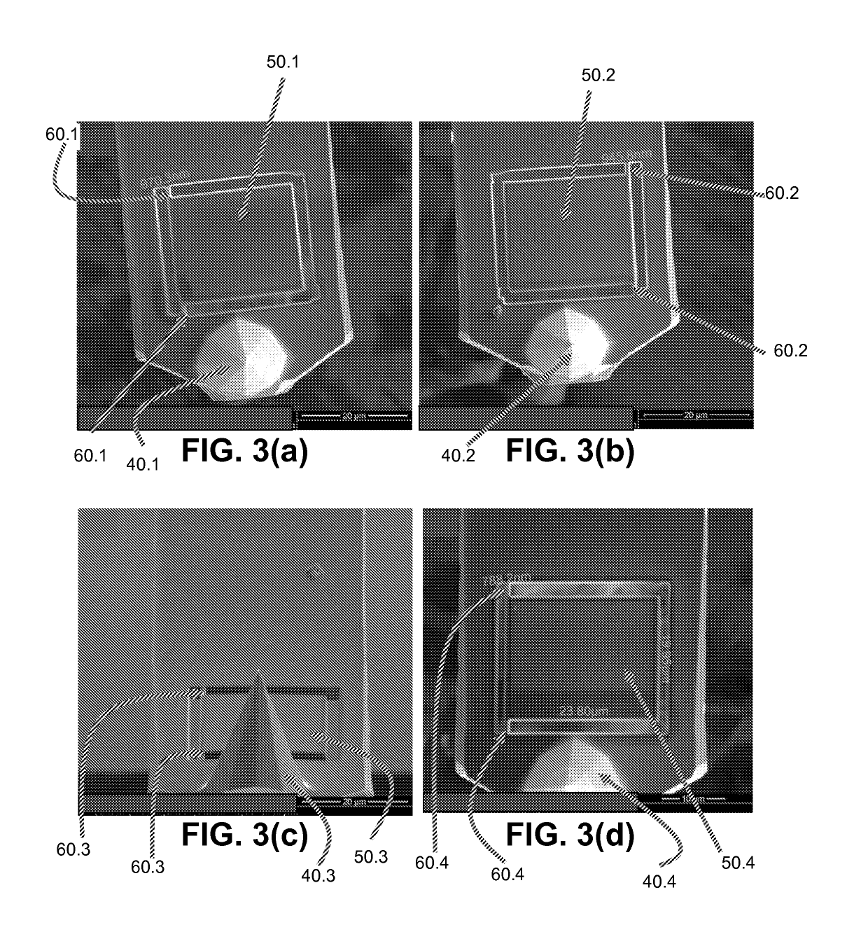

The fabrication of a prototypical hinged cantilever is reasonably simple as shown in FIG. 3. This picture is a scanning electron micrograph of rotational accelerometers that have been cut into the body of commercially available AFM cantilevers using a Ga focused ion beam.

FIG. 1(a) is a generalized schematic diagram of a tapping-mode atomic force microscope 10 according to one embodiment of the present invention. The cantilever 20 is vibrated at a frequency close to one of its flexural resonances, typically the fundamental resonance frequency, in the vicinity of the sample surface 5 so that the tip 40 makes intermittent contacts or interactions (tapping) with the surface. During the scan across the surface, the amplitude of vibration is maintained at a constant value through a feedback loop that adjusts the height of the cantilever base. Specifically, a source of radiation 22 and a detector 26 are used to measure the motion of the cantilever at the driving frequency. Radiation from source 22 is reflected from a target 24 on an accelerometer 50 that is embedded within cantilever probe assembly 20. The radiation incident upon detector 26 therefore includes information pertaining to the motion of the larger, first cantilever 30, as well as the motion of the second cantilever 50.

Microscope 10 includes a feedback control system that is responsive to radiation reflected from target 24 (which is on accelerometer 50). The feedback signal provided by detector 26 includes information related to the gross movement of beam 30 relative to sample 5, as well as information related to relative motion of cantilever 50 relative to cantilever 30. In general terms, the feedback loop moves probe 20 relative to sample 5 upon detection of interaction between tip 40 and the surface of sample 5. In FIG. 1(a), the feedback loop includes an electronic controller (such as one including a microprocessor and memory) 28 and an actuator 27. Controller 28 receives a signal from detector 26, and by way of software 100 processes the detector signal into an actuation signal provided to actuator 27. Actuator 27 responds to the control signal by changing the relative positions of sample 5 and cantilever probe assembly 20.

In some embodiments, microscope 10 includes a detector 26 capable of measuring a doppler shift in the frequency of the radiation, such as a laser doppler vibrometer. As will be discussed later, the frequency content of the signal corresponding to motion of paddle 50 relative to beam 30 occurs at frequencies higher than the tapping frequency (fundamental bending frequency) of beam 30. The radiation reflected from target 24 also includes frequency content related to the higher frequency movement of beam 30. However, since there is sufficient separation between the frequency content of probe 30 motion as compared to the frequency content of paddle 50 motion, the doppler shift provided by gross motion of cantilever 30 is distinct (in terms of doppler shift) from the higher frequency motion of paddle 50. Therefore, one embodiment of the present invention pertains to controlling the movement of sample 50 relative to probe 20 in response to the additional doppler shift provided by second cantilever 50.

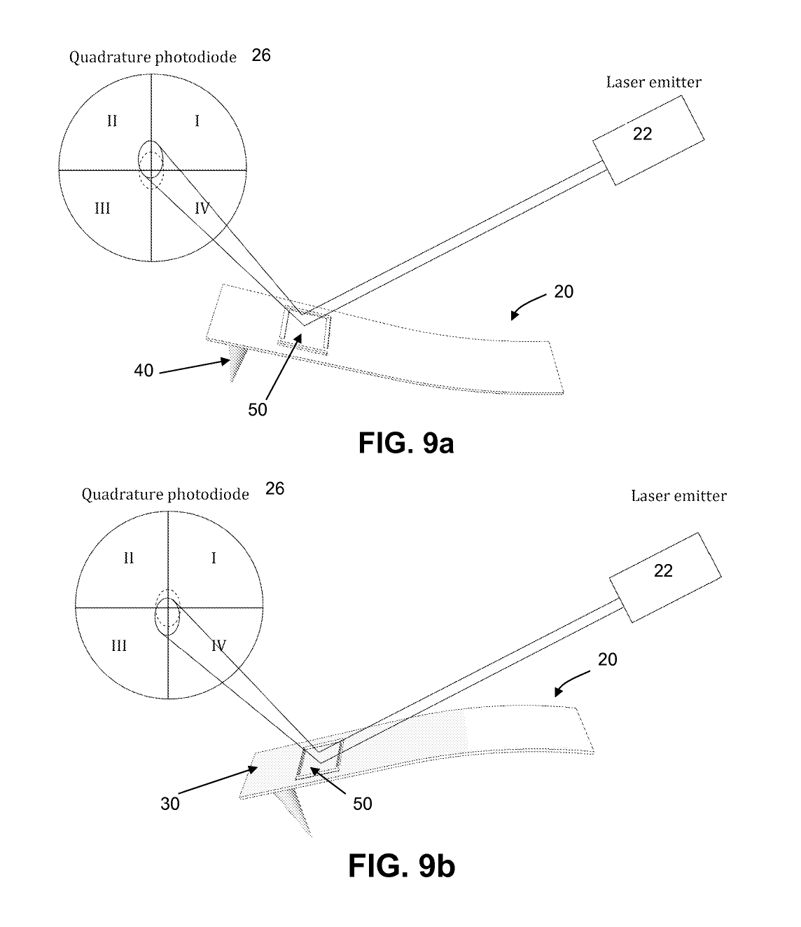

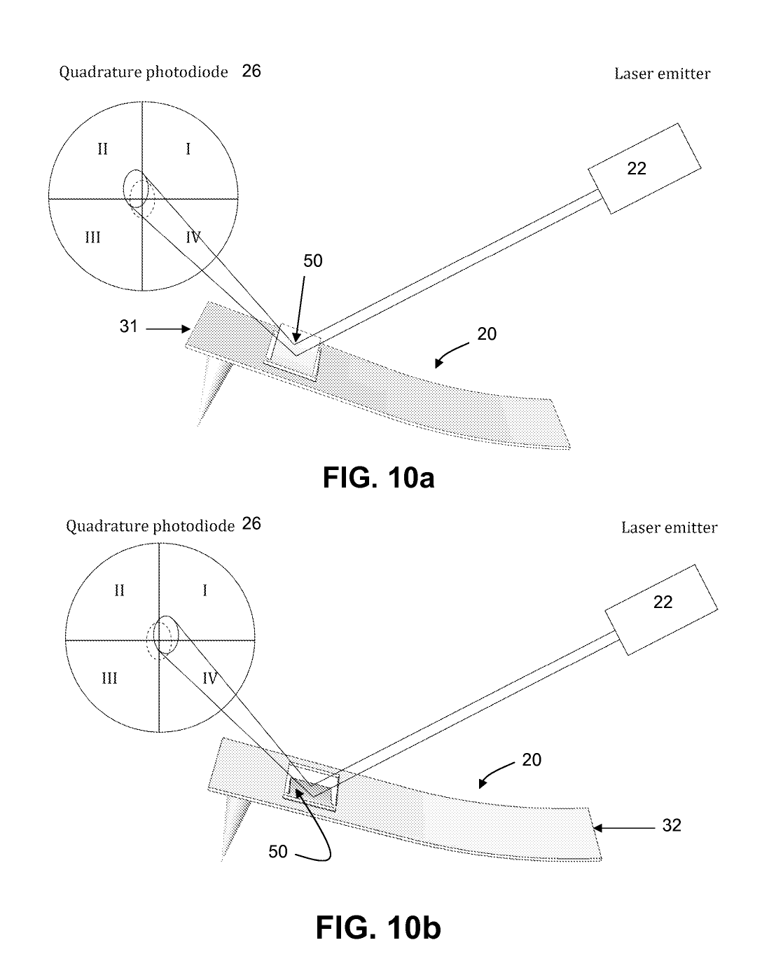

Yet other embodiments of the present invention detect the acceleration of probe 20 by measurement of the bending motion of accelerometer 50 relative to cantilever 30. FIGS. 9 and 10 are schematic representations showing how the flexural or bending motion of the paddle 50 relative to cantilever 30 is detected. FIGS. 9(a) and 9(b) depict (in exaggerated form) the bending of cantilever probe assembly 20. Flexural bending is detected by the difference in the signals between quadrants I+II+III+IV. In FIGS. 9(a) and 9(b) the tip 40 is not interacting with the surface of the sample. Therefore, the movement of probe 20 is oscillatory within a narrow bandwidth (i.e., as one example, at its fundamental resonance frequency). Since paddle 50, considered as a second or compound cantilever, is adapted and configured to have a resonance frequency higher than that of beam 30, there is little or no movement of paddle 50 relative to beam 30. Therefore, the radiation emitted by laser 22 reflects off of the surface of paddle 50 just as if it were reflecting off the surface of a first cantilever beam that did not include a paddle. The reflected radiation is detected by photodiodes 26 as being vertical only (i.e., the radiation illuminating photodiodes 26 is substantially centered).

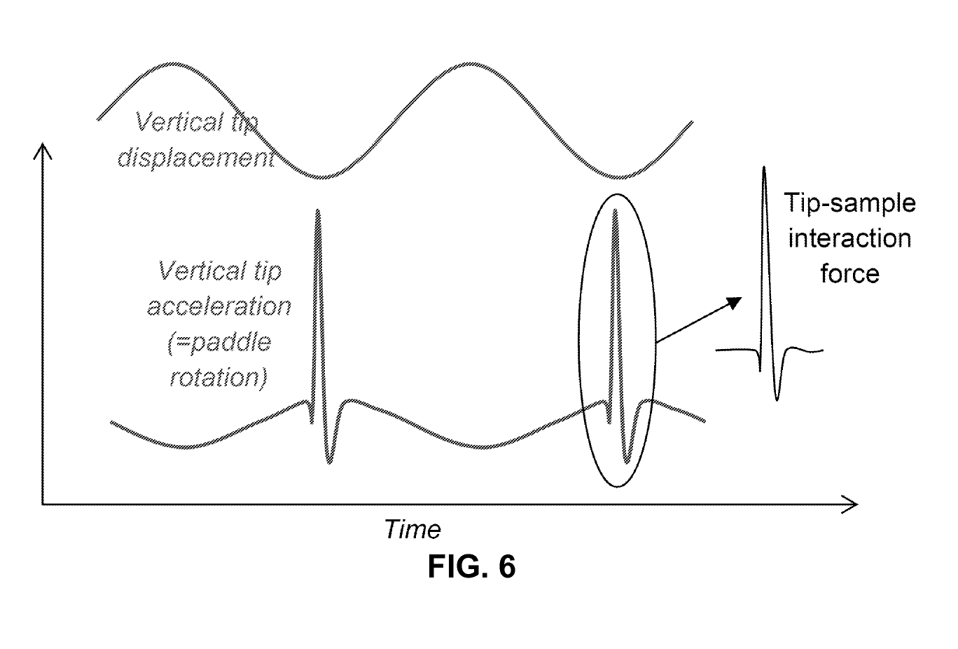

FIG. 10 depict operation of probe assembly 20 during an interaction of tip 40 with the surface of the sample. Acceleration of the tip is detected by the torsional bending of the paddle which is the difference between the signals in quadrants I+IV+II+III. As was discussed with regards to FIG. 6, the bottom trace shows that the interaction forces can be at a frequency that is substantially higher than the tip displacement frequency (which in some embodiments is the resonance frequency of beam 30). Beam 30 is relatively massive compared to paddle 50, and unable to show a detectible tip displacement. However, paddle 50, having a substantially lower mass than beam 30 and further supported from beam 30 by sufficiently flexible hinges 60, shows a bending or flapping response to the disturbance caused by the interaction forces. As shown in FIG. 10(a), paddle 50 can rotate about hinge axis 60 in an upward direction and thereby laterally move the spot of radiation that falls incident on photodiode 26. The spot is no longer centered. As seen in FIG. 10(b), downward motion of paddle 50 relative to beam 30 results in a lateral shift to the right to the spot of incident radiation upon photodiode 26. Based on this lateral movement on photodiode 26, the relative motion of paddle 50 can be detected. Because this relative motion occurs as a result of surface interaction forces, any detection of radiation by photodiode 26 that is not vertically centered can be used to infer that tip 40 is interacting with the surface of the sample.

FIG. 1(b) is a side, perspective, schematic representation of a cantilever probe assembly 20 according to one embodiment of the present invention. Probe assembly 20 includes a generally rectangular cantilever beam structural member 30. Beam 30 is supported in cantilever fashion on any device or object for which it is desired to measure acceleration. In some embodiments, beam 30 is part of an atomic force microscope. However, other embodiments are not so limited, and probe 20 can be used in different types of microscopes that are used for interacting with a sample. Further, yet other embodiments pertain to the use of a cantilever beam 30 (especially with accelerometer 50, as will be described) and coupled to any device for which it is desired to measure acceleration. In some embodiments, apparatus 20 can be referred to a compound cantilever assembly or dual cantilever assembly, referring to a configuration in which a second cantilever (such as paddle 50) is suspended from a first cantilever (such as beam 30).

Beam 30 of probe assembly 20 has a generally rectangular shape, having a length 34a from free end 31 to fixed end 32, and a width 33 from side 35a to side 35b. Although a generally rectangular cantilever beam 30 has been shown and described, the present invention is not so constrained, and yet other embodiments include the use of an accelerometer on triangular-shaped cantilever beams, as well as cantilevers of other shapes.

Located near free end 31 is a probe tip 40 that is adapted and configured for interacting with the surface of a sample. Such interactions may occur as a result of direct contact, whereas other interactions may occur as a result of other forces that arise prior to contact. In some embodiments, probe tip 40 has a sharp tip, and a generally conical or pyramidal shape with a plurality of facets. However, the present invention is not so constrained, and can be used with any type of probe tip, and further can be used in such applications in which there is no probe tip. Preferably, cantilever beam 30 and probe tip 40 are generally symmetrical with regards to a plane of symmetry, shown intersecting the surface of beam 30 by cantilever axis and centerline 36.

Located proximate free end 31 is a second cantilever structure contained between sides 35a and 35b. Cantilever or paddle 50 is hingedly connected to beam 30 by at least one flexible hinge 60. In some embodiments, such as the one shown in FIG. 1, paddle 50 is hingedly connected to beam 30 by a pair of hinges 60, each hinge 60 being located on opposing sides of paddle 50. The hinges 60 define a hinge axis 62 that is generally parallel to axis 36, but offset laterally toward a side of beam 30.

Preferably, hinges 60 are spaced apart by a distance that is greater than about one-half the width of paddle 50. As can be seen in FIG. 2, various embodiments of the present invention contemplate any type of flexural or torsional hinges, which can be connected to panel 50 along the same side, or on opposing sides of panel 50. However, yet other embodiments of the present invention contemplate a single hinge connection between beam 30 and paddle 50, and further those embodiments in which there are more than two hinges.

In some embodiments, paddle 50 is a substantially planar structure, having a top surface that is generally parallel to the top surface of beam 30, and a bottom surface that is generally parallel to the bottom surface of beam 30. Further, in those embodiments in which paddle 50 is etched onto beam 30, the top and bottom paddle surfaces are substantially coplanar with the corresponding top or bottom surface of cantilever 30. Although what has been shown and described is a flat, thin paddle supported in cantilever fashion by a flat, thin cantilever beam, other embodiments of the present invention are not so limited. The present invention further contemplates those embodiments in which the cross sectional shape of the paddle and/or the cross sectional shape of the cantilever beam are not slender rectangular shapes, but rather can be of any cross sectional shape.

In one embodiment, paddle 50 has a center of mass (COM) 54 that is laterally offset from both the cantilever axis 36 and also from hinge axis 62. However, as will be seen in various other embodiments herein, the present invention is not so constrained, and as one example contemplates those embodiments in which the center of mass 54 lies roughly along cantilever axis 36. Likewise, yet other embodiments contemplate a hinge axis 62 that lies generally coincident with cantilever axis 36. Preferably, the center of mass 54 of paddle 50 is laterally offset from hinge axis 62, so as to have a mass and hinges that can be considered as a cantilever mount within beam 30.

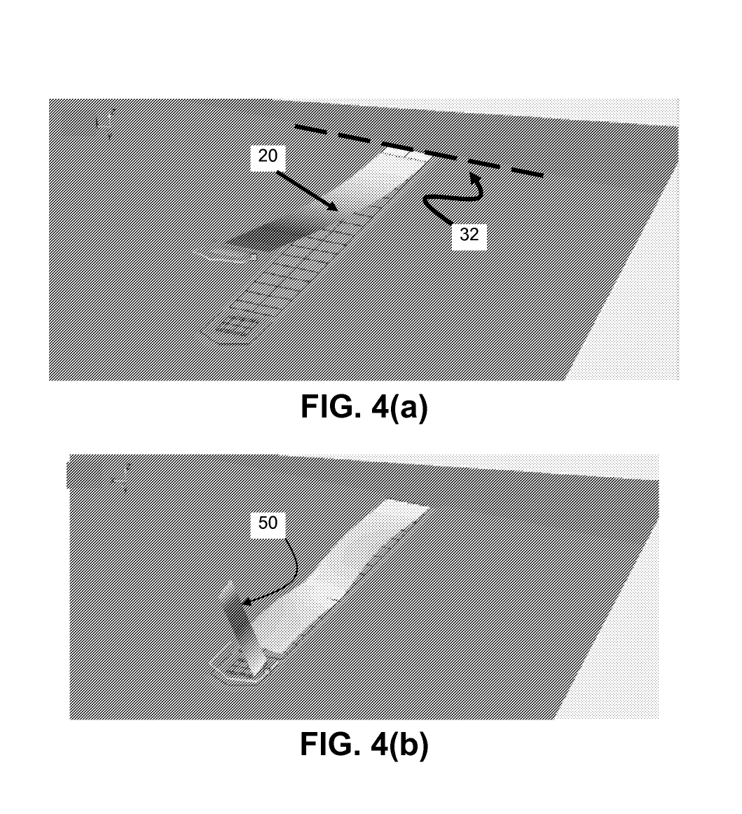

As is best seen in FIG. 4(a), the probe assembly 20 is most flexible in bending, and has a fundamental resonant mode as depicted in FIG. 4(a). The free end 31 of probe 20 can be considered to rotate about an axis defined at the fixed end 32. This assumption is especially true for small deflections of free end 31. FIG. 4(a) characterizes the fundamental mode shape in shades of gray, with fixed end 32 being lightly colored, and indicative of a fixed end (i.e., an end having zero slope approaching the line of attachment 32). However, the present invention is not so constrained, and further contemplates those embodiments in which fixed end 32 can be a hybrid of a fixed end and a pinned end (in which the slope at the end 32 of the cantilever can be non-zero under some conditions).

FIG. 4(a) shows the free end 31 of probe 20 to be darkly colored, indicating relatively large movement from its original (nonvibrating) shape. The free end of beam 30, and generally the length of the beam from the free end to the midpoint of the length, is relatively undeformed in the fundamental bending mode, as compared to the half of the beam from the fixed end 32 to the midpoint of the length.

The state of stress within the cross section of the cantilever is relatively low proximate to the free end, and relatively high proximate to the fixed end. The state of internal stress within beam 30 corresponds to the inertial load being transmitted from the free end toward the fixed end. This inertial load continues to build toward the fixed end, as the amount of mass being supported in cantilever fashion increases in a direction from the free end toward the fixed end.

Various embodiments of the present invention recognize that the free end of cantilever 30 is relatively lightly stressed. Therefore, the inclusion of a paddle-type accelerometer as described herein is structurally acceptable. Even though in some embodiments paddle 50 is attached within an aperture 51 created in the structure of beam 30, the beam material that remains around aperture 51 still provides sufficient stiffness and strength for probe tip 40 as well as paddle 50. Further, locating beam 30 within an aperture 51 near the free end does not remove so much stiffness from beam 30 so as to substantially affect its fundamental vibration mode.

Referring to FIG. 1, it can be seen that aperture 51 is interrupted by torsional hinges 60, especially for those embodiments in which paddle 50 and hinges 60 have been etched within a beam 30. Aperture 51 can be considered as two apertures 51a and 51b. The two apertures are separated by hinges 60. The placement of the second cantilever 50 near the free end of cantilever 30 does not significantly alter the bending stiffness of beam 30 near fixed end 32. Therefore, paddle accelerometers 50 as described herein are suitable candidates for inclusion into an existing cantilever probe, since the fundamental characteristics of the existing probe are not significantly altered.

Referring to FIG. 3, there are shown four photographic representations of paddles that have been etched within an existing cantilever beam proximate to the tip and free end. FIG. 3 each show a paddle suspended in cantilever fashion (as a second cantilever) from a cantilever beam. The elements shown in FIG. 3 are of generally the same configuration, but the result of different fabrication trials. The four different configurations are represented by the suffixes 0.1, 0.2, 0.3, or 0.4, which correspond to the respective photograph (a), (b), (c), or (d), respectively. It is understood that the features 40, 50, and 60 are the same as otherwise described herein, except for the specific features shown and described with regards to the specific suffix.

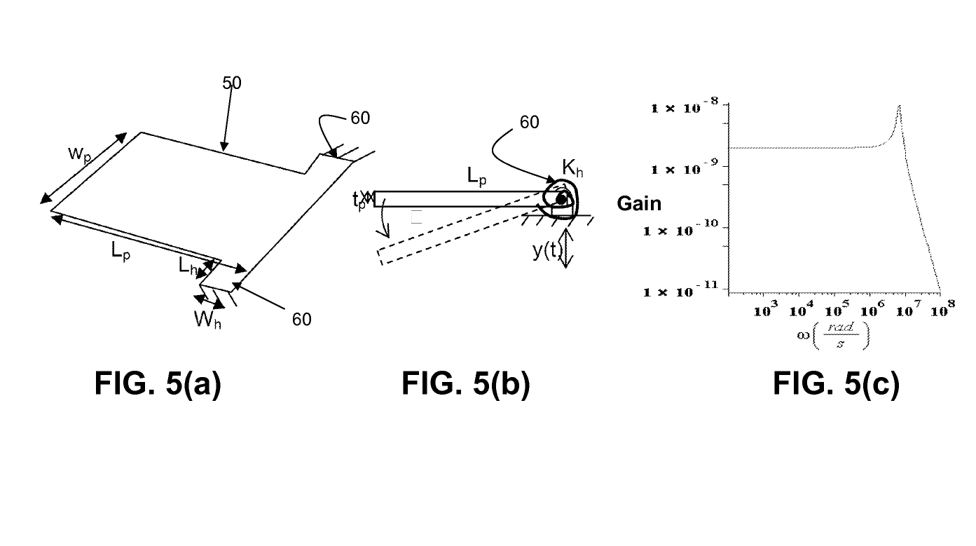

FIG. 3(a) shows a paddle 50.1 supported by a pair of flexible hinges 60.1. Hinges 60.1 have a width Wh (as noted in FIG. 5(a)) of about 970 nanometers. Further, it can be seen that paddle 50.1 has a planar area that is substantially on one side of the hinges, in contrast to the paddle 50 shown in FIG. 1 in which the hinges 60 are midway along the length Lp of paddle 50, with portions of the paddle on either side of hinge axis 62. In FIG. 3(a), there is substantially no mass of paddle 50 on one side of the hinge axis.

FIG. 3(b) shows yet another fabrication trial in which the hinge width Wh is about 946 nm. Further, FIG. 3b shows a hinge placement on the other side of the centerline of the cantilever beam, as compared to the hinge structure of FIG. 3(a)

FIG. 3(c) shows a probe 50.3 photographed at a shallower angle than the angle as used in FIG. 3(a). FIG. 3(d) shows a paddle 50.4 that is suspended in cantilever fashion by hinges 60.4 that have a width Wh of about 788 nm. FIG. 3 are all scaled photographs.

The vibration characteristics of such a cantilever have also been measured using the MSA400 Scanning Laser Vibrometer for Microsystems in the Birck Nanotechnology Center. FIG. 6 shows a graphical representation of vertical tip motion time history and tip acceleration. The paddle rotation is proportional to the vertical tip acceleration. While the tip motion appears mostly harmonic, the acceleration signal clearly shows the short pulses of accelerations due to tip-sample interactions during tap events.

For example in FIG. 6, the magnitude of the eigenmodes of the fundamental mode (about 55 kHz) and that of the paddle resonance (1.2 MHz) can be seen (these data were acquired for the cantilever in FIG. 3c). The paddle resonance has a first natural frequency (1.2 MHz) and a resonance with a Q factor of about 1000. Paddle rotation is expected to be proportional to vertical tip acceleration for up to about the first 20 harmonics of the drive frequency in some embodiments. The results also show that the fundamental eigenmode is substantially unchanged by the inclusion of the paddle in the design. The inclusion of the paddle is generally non-intrusive and does not influence the original properties (stiffness, first eigenmode etc.) of the cantilever onto which it is embedded.

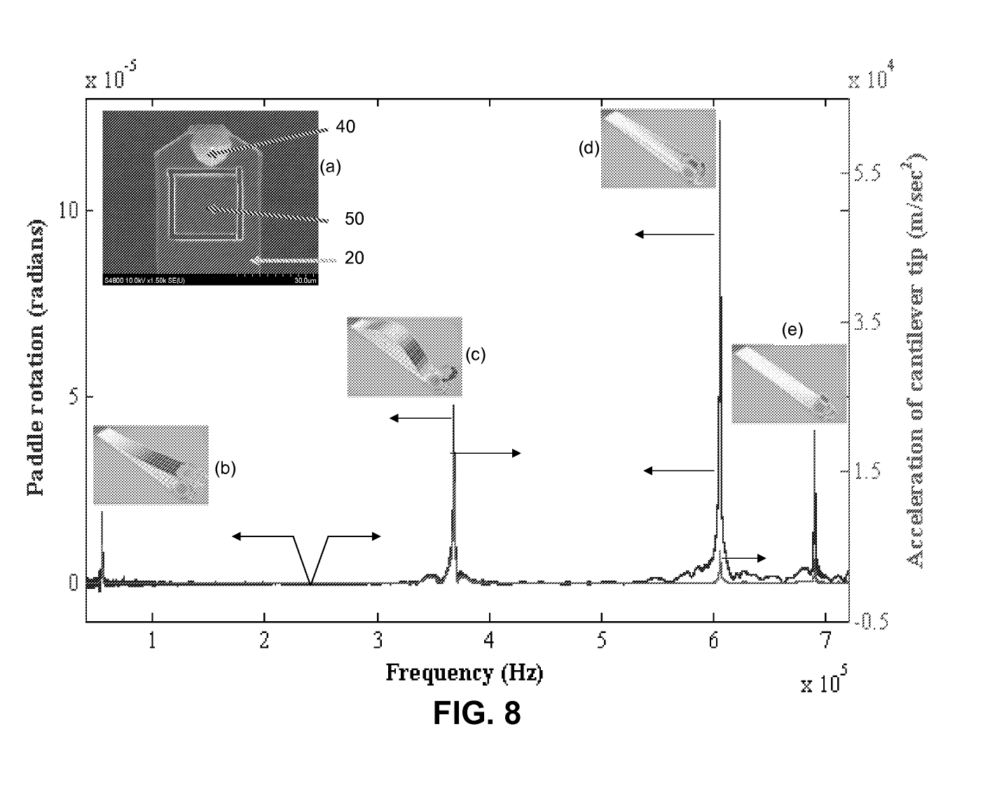

The paddle rotation of one probe vs. vertical tip acceleration was measured using the MSA400 Scanning Laser Doppler Vibrometer. The cantilever was excited vertically on a dither piezo and its normal vibration at the tip and at two ends of the paddle that define its rotation were measured over a broad frequency range. The results are shown in FIG. 8. FIG. 8 shows experimental results measured using the MSA400 Polytec Vibrometer to measure the paddle rotation and vertical tip acceleration as the cantilever is excited over a broad band of frequencies. The inset (a) shows the probe used. The inset (b) shows pictorially the fundamental bending mode of the cantilever probe assembly 20. Inset (c) shows a higher order bending mode of cantilever assembly 20. Insets (d) and (e) show yet higher modes of oscillation. The paddle 50 torsional resonances start at about 0.6 MHz.

The paddle rotation angle is linearly proportional to the vertical tip acceleration over a large frequency range (about 0.5 MHz for this lever). The cantilever probe assembly 20 exhibited a fundamental resonance at about 55 kHz. The relationship between the rotational angle of paddle 50 and the vertical acceleration of tip 40 correlate well with each other, with the correlation not breaking down until around 0.6 MHz. Therefore, the accelerometer 50 is able to transduce linearly up to 9 harmonics of the acceleration induced due to tip sample interaction forces.

This study also highlights certain simple design considerations for the paddle resonator. Referring to FIGS. 4(a) and 4(b), the fundamental eigenmodes of the probe assembly 20 and paddle 50 are shown, respectively, in an exaggerated scale. FIG. 4(a) shows the fundamental eigenmode of probe assembly 20 to be at about 55 KHz, and FIG. 4(b) shows the paddle 50 having a resonator mode at about 1.2 MHz. FIG. 4(b) shows that the paddle resonance is accompanied by a small component of second torsional mode of the cantilever since the paddle resonance is not far from the second torsion resonance mode (about 1 MHz). To minimize this coupling, the paddle hinge stiffness could be increased to increase the paddle resonance even higher; or alternately the hinge stiffness could be decreased to bring the paddle resonance frequency between the first and second torsion frequency. Such frequency detunings can be accomplished by simply changing the local properties of the hinge and paddle.

An understanding the functioning of the paddle accelerometer and its design considerations according to some embodiments can be obtained using a simple mathematical model. Some dimensions of the paddle are denoted in FIG. 5(a). In addition tₚ and tₕ are respectively the thicknesses of the paddle and the hinge respectively. Since the hinge is narrow, a simple model of the paddle accelerometer is that of a rigid body (a paddle of dimensions Lₚ×wₚ×tₚ, as can be seen in FIG. 5(a)) that rotates about the hinge axes and is restrained by a torsional spring of stiffness Kₕ (N·m/rad). The net torsional stiffness Kₕ of the pair of hinges along the hinge axis is given by (when wₕ>tₕ)

$${K}_{h} = 2 {Gw}_{h} {t}_{h}^{3} ( \frac{1}{3} - 0.21 ( \frac{{t}_{h}}{{w}_{h}} ) ( 1 - {( \frac{{t}_{h}}{{w}_{h}} )}^{4} / 12 ) ) / {L}_{h} \qquad ( 1 )$$

where G is the shear modulus of the material (about 80 GPa for silicon).

Considering FIG. 5(b), the equation of rotational motion of the paddle about the hinge axis is given by

$${I}_{p} \frac{{d}^{2} θ}{d {t}^{2}} + c \frac{d θ}{d t} + {K}_{h} θ = ( \frac{{m}_{p} {L}_{p}}{2} ) \frac{{d}^{2} y}{d {t}^{2}} \qquad ( 2 )$$

where

$${I}_{p} = {m}_{p} ( \frac{{h}_{p}^{2} + {t}_{p}^{2} + 3 {L}_{p}^{2}}{12} )$$

is the rotational inertia of the paddle about the hinge axis, mₚ=ρLₚwₚtₚ is the mass of the paddle (ρ being the mass density, i.e. 2330 kg/m³ for silicon), and c represents the damping arising primarily from fluid drag on the paddle as it oscillates. Eq. (2) can be rewritten as:

$$\frac{{d}^{2} θ}{d {t}^{2}} + \frac{{ω}_{n}}{Q} \frac{d θ}{d t} + {ω}_{n}^{2} θ = ( \frac{{m}_{p} {L}_{p} / 2}{( \frac{{h}_{p}^{2} + {t}_{p}^{2} + 3 {L}_{p}^{2}}{12} )} ) \frac{{d}^{2} y}{d {t}^{2}} \qquad ( 3 )$$

where

$${ω}_{n}^{2} = \frac{12 {K}_{h}}{{m}_{p} ( {w}_{p}^{2} + {t}_{p}^{2} + 3 {L}_{p}^{2} )}$$

is the square of the natural frequency of the paddle resonator (the subscript n in ωₙ denotes the natural frequency), and

$$Q = \frac{{ω}_{n} {I}_{p}}{c}$$

is the quality factor of resonance of the paddle accelerometer. To develop a transfer function for input-output response, allow y(t)=Y(ω)e^{iωt} and θ(t)=Θ(ω)e^{iωt}. Using Fourier transforms of both sides of Eq. (3), it can be shown that

$$Gain ( rads / ( m / {s}^{2} ) ) = \frac{\vert Θ \vert}{\vert Y {ω}^{2} \vert} = ( \frac{{L}_{p} {m}_{p}}{2 {K}_{h}} ) \frac{1}{\sqrt{{( 1 - {( \frac{ω}{{ω}_{n}} )}^{2} )}^{2} + \frac{1}{{Q}^{2}} {( \frac{ω}{{ω}_{n}} )}^{2}}} \qquad ( 4 )$$

so that the two metrics for the paddle accelerometer are its bandwidth

$${ω}_{n} = \sqrt{\frac{12 {K}_{h}}{{m}_{p} ( {w}_{p}^{2} + {t}_{p}^{2} + 3 {L}_{p}^{2} )}}$$

and its gain when ω<<ωₙ which is given simply by

$$( \frac{{L}_{p} {m}_{p}}{2 {K}_{h}} ) .$$

To demonstrate the predictions, consider a simple silicon paddle accelerometer geometry in which:

Lₚ=wₚ=20 microns; tₚ=1 micron; Lₕ=2 microns; wₚ=0.5 microns; tₚ=1 micron.

Based on the formulas above, the bandwidth of this accelerometer (its natural frequency, ωₙ) will be about 0.7 MHz and its zero frequency gain about 5×10⁻⁸ rads/(m/s²). See FIG. 5c where the gain given by Eq. (4) is plotted for the above geometric paddle parameters and with a Q-factor of 5. A sharp resonance is observed when the drive frequency equals the resonant frequency of the paddle accelerometer. If this accelerometer is embedded in a 75 KHz cantilever (far below the resonance of the accelerometer) oscillating with 5 nm amplitude, this will lead to a rotational amplitude in the paddle of about 5 microradians which can be detected in commercial AFM systems. Thus this paddle will be able to transduce the vertical acceleration produced by a 5 nm oscillation amplitude at 75 kHz, i.e. be able to resolve an acceleration of about 100 g's.

FIG. 2 show various embodiments of the present invention in which an accelerometer or paddle X50 is mounted as a second cantilever within a first cantilever X20. The paddles X50 are supported from beam X30 by a pair of flexible hinges X60. Beam X30 and tip X40 are symmetric about a plane shown as a centerline X36. In some embodiments, the hinges X60 permit flexing about an axis X62 that is substantially orthogonal to the fixation X32 of beam X30. Further, paddles X50 are generally coplanar with beam X30. Because of the orientation of rotational axis X62, the motion of paddle X50 is substantially normal to the planar surface of beam X30. It is appreciated that the movement of paddle X50 is most rigorously defined as rotational movement about axis X62. However, for small movements, and at the limit as the motion of paddle X50 relative to cantilever X30 approaches zero, the relative movement can be considered normal and vertical.

FIG. 2(a) shows an accelerometer or paddle 150 suspended in cantilever fashion by a pair of torsional hinges 160 from beam 130. The configuration of hinges 160 are similar to the hinge configurations seen in FIG. 3. In comparison to paddle 50, paddle 150 does not include any substantial amount of mass on one side of hinge axis 162. Hinge axis 162 is displaced laterally from centerline X36. Paddle X50 is substantially symmetrical about paddle centerline X56.

FIG. 2(b) shows an accelerometer or paddle 250 suspended in cantilever fashion by a single flexural hinge 260 from beam 230. Similar to paddle 150, paddle 250 does not include any substantial amount of mass on one side of hinge axis 262. Hinge axis 262 is displaced laterally from centerline 236. Paddle 250 is substantially symmetrical about paddle centerline 256.

FIG. 2(c) shows an accelerometer or paddle 350 suspended in cantilever fashion by a pair of torsional hinges 360 from beam 330. Paddle 350 includes a portion of its mass on each side of hinge axis 362. Hinge axis 362 is displaced laterally a small distance from centerline 336. The center of mass (COM) 354 of paddle 350 is displaced laterally from hinge axis 362. In some embodiments, hinge axis 362 is generally coincident with centerline 336. Paddle 350 is substantially symmetrical about paddle centerline 356.

FIG. 2(d) shows an accelerometer or paddle 450 suspended in cantilever fashion by a pair of torsional hinges 460 from beam 430. Paddle 450 includes a portion of its mass on each side of hinge axis 462. Hinge axis 462 is coincident with centerline 436. Paddle 450 is substantially symmetrical about paddle centerline 456. Paddle 450 has a mass on one side of hinge axis 462 that is different in shape than the mass on the other side.

FIG. 2(e) shows an accelerometer or paddle 550 suspended in cantilever fashion by a pair of spaced apart flexural hinges 560 from beam 530. Paddle 550 does not include any substantial amount of mass on one side of hinge axis 562. Hinge axis 562 is displaced laterally from centerline 536. Paddle 550 is substantially symmetrical about paddle centerline 556. However, it is appreciated that the width of panel 550 (normal to hinge axis 560) could be shorter on the side of the paddle that is opposite of the hinged side. In so doing, the center of mass of paddle 550 can be moved laterally (to the right as shown in FIG. 2(e)).

As shown and described herein, paddles X50 are a relatively close fit within their respective apertures X51. In some embodiments, the gap between an edge or side of the paddle to the corresponding wall of the aperture in the beam is about the same as the diameter of the ion beam used to cut the paddle within the beam. However, other embodiments of the present invention are not so constrained, and contemplate paddle shapes that are different than the shape of the aperture, and further those paddle sizes that are of a different size than the aperture. With regards to the former and as examples, various embodiments contemplate the placement of a round paddle in a square aperture, or a square paddle in a round aperture. With regards to the latter, the uniform gap seen around paddles 250, 550, 650, and 850 (as examples) do not need to be uniform. Specifically, paddle 550 could have a relatively short width, but located within an aperture of greater width, thereby creating a larger gap along the free edge.

Further, what has been shown and described herein are spaced apart hinges that are generally located symmetrically about a centerline of the paddle. However, the present invention is not so constrained, and contemplates asymmetric locations of the hinges to produce desired flexural response of the paddle. In addition, what is shown and described herein are a pair of hinges in which each hinge is of the same type (i.e., two torsional hinges or two flexural hinges). However, it is appreciated that other embodiments are not so constrained, and contemplate mixed arrangements of hinges (as one example, replacing one of the torsional hinges 860 with a flexural hinge), in order to achieve particular flexural characteristics of the paddle.

FIG. 2(f) shows a round accelerometer or paddle 650 suspended in cantilever fashion by a pair of flexural hinges 660 from beam 630. Hinges 660 are oriented in a generally radial manner. Paddle 650 does not include any substantial amount of mass on one side of hinge axis 662. Hinge axis 662 is displaced laterally from centerline 636. Paddle 650 is substantially symmetrical about paddle centerline 656.

FIG. 2(g) shows an accelerometer or paddle 750 suspended in cantilever fashion by a pair of torsional hinges 760 from beam 730. Paddle 750 does not include any substantial amount of mass on one side of hinge axis 762. Hinge axis 762 is oriented orthogonally from centerline 736. Paddle 750 is substantially symmetrical about beam centerline 736.

FIG. 2(h) shows an accelerometer or paddle 850 suspended in cantilever fashion by a pair of torsional hinges 860 from beam 830. Paddle 850 does not include any substantial amount of mass on one side of hinge axis 862. Hinge axis 862 is displaced laterally from and is parallel to centerline 836. Paddle 850 is substantially symmetrical about paddle centerline 856. The hinges 860 are displaced outwardly from the sides of paddle 550, thus giving paddle 550 a larger “wheelbase.”

FIG. 2(i) shows an accelerometer or paddle 950 suspended in cantilever fashion by a pair of hinges 960 from beam 930. Paddle 950 does not include any substantial amount of mass on one side of hinge axis 962. Hinge axis 962 is displaced laterally from centerline 936. Center of mass 954 is displaced laterally on the other side of centerline 936. Paddle 950 is substantially symmetrical about paddle centerline 956. Note that hinges 960 include portions that flex, as well as other portions that are in torsion as paddle 950 moves relative to beam 930.

A method according to another embodiment of the present invention is presented in this example which illustrates one way to calibrate the output of the rotational motion to vertical acceleration of the tip. The first act is a calibration of the flexural deflection of the cantilever, which involves deflecting the cantilever a known deflection at low frequency, such that the acceleration of the tip is negligible. This is achieved, for example, by displacing the base that retains probe 20 by a known displacement while tip 40 is in contact with a stiff sample. The displacement can occur at a frequency much lower than the fundamental resonance. The displacement of the base is approximately equal to the flexural deflection of the tip of the cantilever. In general, there may be a small reading in torsion signal because the laser/photodiode setup may not be sufficiently aligned axially along the cantilever. This is what “crosstalk,” and it is accounted for in this step.

The second act is a calibration of paddle calibration 50. The cantilever 30 is driven to oscillate harmonically at the fundamental resonance frequency of the cantilever 30, and in the absence of the sample. Subtracting the flexural deflection of the cantilever 30 from the photodiode signal yields a corrected signal corresponding to the response of the paddle 50. The response of the paddle 50 divided by the acceleration of the tip is the gain of the paddle, in terms of [angular units/acceleration units]. The acceleration of tip is known for the simple case of harmonic oscillations simply from measuring the cantilever deflection, which is simply the deflection signal scaled by a factor of minus the square of the frequency.

First the cantilever is oscillated harmonically in its fundamental eigenmode at a frequency ω with a large tip amplitude (for example, A greater than about 50 nm preferably). The amplitude can be calibrated using existing methods in commercial AFM systems. The maximum tip acceleration is then Aω² and the rotational paddle motion measurement is calibrated to the known tip acceleration.

An aspect of the design proposed above is the inherent relative motion of the hinge with respect to the cantilever body. Whenever two objects execute such relative motion, a variety of electronic detection schemes to detect their motion becomes possible. As one example, a well established electronic detection device such as an impedance bridge can be used to accurately sense the relative motion of the hinged cantilever's rotation. Such an embellishment could eliminate any need to direct a focused laser beam onto the cantilever. Furthermore, it should be clear that such an electronic detection scheme could be assisted by the addition of appropriate electrodes to the cantilever. In some embodiments of the present invention, if the paddle rotation can be measured electrically, then the paddle hinge axis need not be parallel to the cantilever axis ensuring that the accelerometer does not cause mass imbalance about the cantilever axis (see FIG. 2f).

A further aspect of this overall design is the possibility that a paddle can be added to an existing cantilever rather than cut into one. This possibility would form an additive processing path rather than a subtractive processing path.

In yet other embodiments for such cantilevers with rotational paddle accelerometer, the paddle accelerometer's resonance frequency can be tuned to lie close to an integer multiple of the fundamental frequency. This can be simply performed by designing the hinges or paddle geometry, or by adding a geometric feature to the paddle. In this case there will be energy transfer between the oscillating tip and the rotational paddle motion when the tip taps on the surface. The rotational paddle motion is expected in this case to be sensitive to sample properties such as chemical composition or local adhesion or elasticity.

In yet another embodiment for a cantilever with a rotational paddle accelerometer, added mass on the paddle may be designed by including geometric features that can increase the mass or moment of inertia of the paddle to increase its acceleration sensitivity.

When soft cantilevers tap on samples in liquids, the second eigenmode can be momentarily excited. This causes unwanted harmonics to appear in the accelerometer signal. To remedy this, one embodiment for applications in liquids is to place the paddle accelerometer at the axial position unresponsive to the vibration node of the second eigenmode. In this manner the accelerometer will not pick up unwanted signal from the second eigenmode. This is helpful for the calibration of higher eigenmodes. It is simpler to back out tip-sample force from the rotational signal if it is proportional to the tip acceleration in a single eigenmode.

The paddle rotation measurement can be converted into tip-sample interaction force in near real-time, while scanning the sample in tapping mode or other dynamic AFM modes. When a cantilever taps on a sample in air it can be shown that the vertical tip motion is largely harmonic while its acceleration is quite anharmonic, showing short pulses when the tip swings down to tap on the sample. In liquids the situation is slightly different and the tip deflection signal shows distortions when the tip taps the sample, however the acceleration signal still shows the tip-sample force pulse.

Because the paddle rotation is proportional to vertical tip acceleration, its time history is essentially the time history of forces acting on the tip (See FIG. 6). Measurement of the tip-sample force pulse can reveal quantitative estimates of local elasticity, chemistry, adhesion and many other local properties. Various embodiments of the present invention include methods can be used to extract the tip-sample force from the paddle rotation waveform:

A method according to one embodiment considers that the paddle rotation in a plurality of cycles of oscillation can be averaged (auto-correlated) over a few oscillation cycles as the tip taps on a particular point on the sample. As the tip scans over the sample, these averaged tip-sample force histories can be recorded. In yet another embodiment, instead of recording the tip-sample force history at each point on the sample, it is also possible to measure its Fourier coefficients (i.e. higher harmonic amplitude and phase), and a finite number of Fourier coefficients of the rotation signal can be used to reconstruct the tip-sample force at each point on the sample.

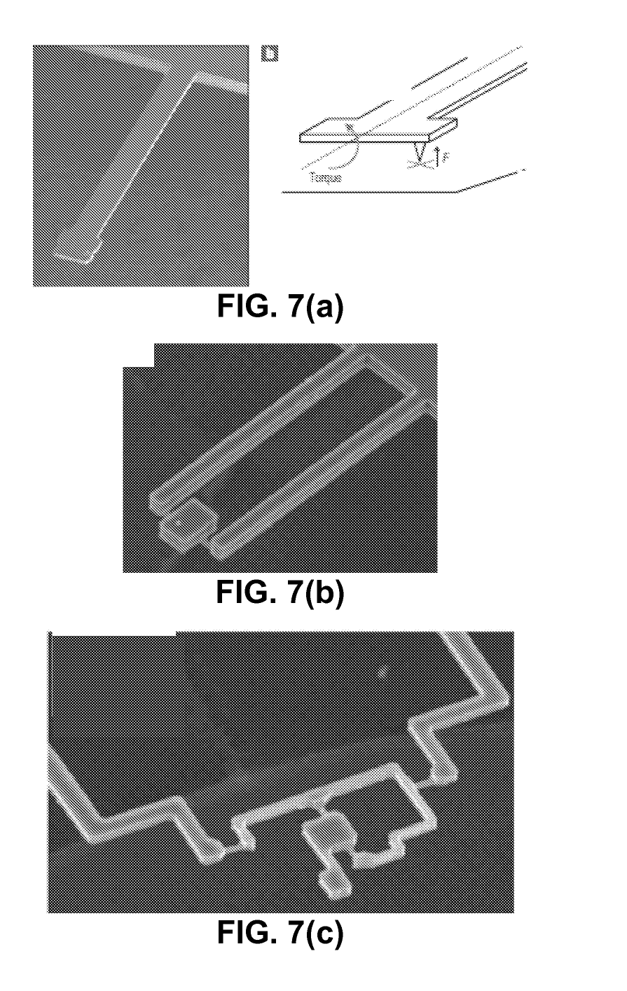

One alternative to Fourier coefficients can be the use of wavelet analysis on the paddle rotation time history. Instead of recording Fourier coefficients at various points on the sample it is also possible to record a plurality of wavelet coefficients of the paddle rotation signal. Then the recorded wavelet coefficients over different points on the sample can be used to reconstruct tip-sample interaction forces over the sample, in near real-time. For reference, the types of cantilever technologies proposed in prior works are shown in FIG. 7.

What follows are statements which describe various embodiments of the present inventions. The following statements are not intended to be an exhaustive such list. It is to be appreciated that some of these statements may be redundant. Furthermore, these statements are interpreted in terms of what one of ordinary skill in the art would understand.

A statement S1 of one embodiment of the present invention pertains to an apparatus for scanning a sample with a microscope, comprising a cantilever beam having two opposing ends, one end being held within the microscope and the other end being free, the beam being rotatable in a first direction about the fixed end; a tip extending from the beam proximate the free end, the tip being adapted and configured for interacting with the sample; and a paddle coupled to the beam by at least one hinge and rotatable relative to the beam in a second direction about the hinge, the second direction being substantially orthogonal to the first direction; wherein the beam has a planar surface from the free end to the held end, and movement of the paddle about the hinge is substantially normal to the planar surface.

A statement S2 of one embodiment of the present invention pertains to an apparatus for scanning a sample with a microscope, comprising a cantilever beam having two opposing ends, one end being fixed within the microscope and the other end being free, the beam being bendable about the fixed end; a tip affixed to the beam proximate the free end the tip being adapted and configured for interacting with the sample, the beam and the tip being substantially symmetrical about a plane; and a paddle coupled to the beam by two spaced apart hinges defining an axis, the paddle being bendable relative to the beam about the axis, the paddle having a center of mass; wherein at least one of the center of mass or the hinge axis is laterally offset from the plane.

A statement S3 of one embodiment of the present invention pertains to a method for modifying a probe for scanning a sample with an atomic force microscope, comprising providing a probe assembly useful for atomic force microscopy, the assembly including a cantilevered planar structural member with a tip; cutting a paddle through the plane of the structural member; and hinging the paddle to the structural member.

A statement S4 of one embodiment of the present invention pertains to a method for scanning the surface of a sample, comprising providing a cantilevered probe having a tip for interacting with the surface, the probe including a sensor that provides a response to acceleration of the probe; driving the probe in bending at a frequency; moving the driven probe toward the surface and interacting the tip with the surface; accelerating the probe by the act of interacting; and measuring the response of the sensor during the act of acceleration.

A statement S5 of one embodiment of the present invention pertains to a method for calibrating a cantilevered probe of a microscope, comprising: providing a first cantilevered probe that supports a paddle in cantilever manner, the first probe having a first end and a second end; contacting the first end of the first probe against a surface; bending the second end of the first probe relative to the stationary first end by a known distance; oscillating the first probe during the act of bending at a frequency lower than the fundamental resonance mode of the first probe; measuring the flexural response of the first probe; supporting the first probe by the second end with the first end being free to move; vibrating the supported first probe at the fundamental resonance mode of the first probe; measuring the bending response of the paddle during the act of vibrating; and correcting the bending response by the flexural response and determining the acceleration of the fee end of the first probe.

Statements pertaining to yet other embodiments of the present invention include any of the statements S1, S2, S3, S4, or S5 in combination with any of the following:

wherein the paddle has a pair of opposing ends, with one end of the paddle being supported by the hinge and the other end of the paddle being free;

wherein the paddle has an axis of symmetry that is substantially orthogonal to the hinge axis;

wherein the beam has an axis of symmetry, the paddle has a center of mass, and the center of mass is laterally offset from the axis of symmetry;

wherein the paddle has a center of mass, the hinge permits rotation about a hinge axis, and the center of mass is spaced apart from the hinge axis;

wherein the beam and the tip share a plane of symmetry;

wherein the paddle has a planar surface that is substantially coplanar with the planar surface of the beam;

wherein the beam is generally rectangular;

wherein the beam is generally triangular;

wherein the beam has two opposing sides, and the paddle is located between the sides;

wherein the paddle is located proximate to the tip;

wherein the beam has a length from the fixed end to the free end, and the paddle is located along the length at a position between the free end and the midpoint of the length;

wherein both the center of mass and the hinge axis are laterally offset from the plane;

wherein the center of mass is laterally offset to one side of the plane and the hinge axis is laterally offset to the other side of the plane;

wherein the other of the center of mass of the hinge axis lies generally within the plane;

wherein the paddle has a width, and the hinges are spaced apart by more than about one half of the width;

wherein each the hinge is adapted and configured to elastically deform in torsion when the paddle rotates about the hinge axis;

wherein each the hinge is adapted and configured to elastically deform in flexure when the paddle rotates about the hinge axis;

wherein the hinges are sufficiently flexible such that the motion of the paddle about the axis is substantially that of a rigid body in torsion about the axis;

wherein the hinges are sufficiently flexible such that the motion of the paddle about the axis is substantially that of a rigid body in bending about the axis;

which further comprises a laser and a photodiode array, the laser emitting radiation that is reflected from the paddle onto the array;

wherein the beam has a first fundamental resonant frequency, the paddle has a second fundamental resonant frequency, and the second frequency is greater than about one hundred fifty percent of the first frequency;

wherein the second frequency is an integer multiple of the first frequency. wherein the act of cutting is with an ion beam;

wherein the probe assembly includes a target for reflecting radiation, and the act of cutting is around the target;

wherein the act of hinging is by cutting around hinges in the structural member;

wherein the act of providing includes a source of radiation and a radiation detector, and the act of measuring is by reflecting source radiation by the sensor onto the detector;

wherein the act of reflecting is in a direction lateral to the direction of bending. wherein the act of driving is at the fundamental bending frequency of the cantilevered probe;

wherein the act of sensor has a lowest natural frequency that is greater than about one and one-half times the bending frequency;

wherein the sensor responds to acceleration by bending about a hinge;

wherein the sensor responds to acceleration with torsional movement about a hinge;

wherein the sensor has a center of mass that is supported as second cantilever by the cantilevered probe;

wherein the act of providing includes an electronic controller operably connected to an actuator, the actuator capable of receiving a signal from the controller and moving the sample relative to the probe in response thereto, the act of measuring is by the controller, and which further comprises moving the sample relative to the probe in response to the act of measuring;

wherein the detector is capable of measuring a doppler shift in the frequency content of the radiation, and the act of measuring is of the doppler shift; and

wherein the detector is capable of measuring an angular relationship between the probe and the sensor, and the act of measuring is of the relative angle.

While some inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed:

1. An apparatus for scanning a sample with a microscope, comprising:
a cantilever beam having two opposing ends, one end being fixed within the microscope and the other end being free, said beam being bendable about the fixed end;
a tip affixed to said beam proximate the free end said tip being adapted and configured for interacting with the sample, said beam and said tip being substantially symmetrical about a plane; and
a paddle coupled to said beam by two spaced apart flexible hinges defining an axis, said paddle being bendable relative to said beam about the axis, said paddle having a center of mass;
wherein at least one of the center of mass or the hinge axis is laterally offset from the plane.

2. The apparatus of claim 1 which further comprises a laser and a photodiode array, the laser emitting radiation that is reflected from said paddle onto said array.

3. The apparatus of claim 1 wherein said beam has a first fundamental resonant frequency, said paddle has a second fundamental resonant frequency, and the second frequency is greater than about one hundred fifty percent of the first frequency.

4. The apparatus of claim 3 wherein the second frequency is an integer multiple of the first frequency.

5. The apparatus of claim 1 wherein said paddle has a width, and said hinges are spaced apart by more than about one half of the width.

6. The apparatus of claim 1 wherein both the center of mass and the hinge axis are laterally offset from the plane.

7. The apparatus of claim 1 wherein the center of mass is laterally offset to one side of the plane and the hinge axis is laterally offset to the other side of the plane.

8. The apparatus of claim 1 wherein the other of the center of mass of the hinge axis lies generally within the plane.

9. A method for scanning the surface of a sample, comprising:
providing a cantilevered probe having a tip for interacting with the surface, the probe including a sensor that provides a response to acceleration of the probe;
driving the probe in bending at a frequency;
moving the driven probe toward the surface and interacting the tip with the surface;
accelerating the probe by said interacting; and
measuring the response of the sensor during said acceleration.

10. The method of claim 9 wherein said providing includes a source of radiation and a radiation detector, and said measuring is by reflecting source radiation by the sensor onto the detector.

11. The method of claim 9 wherein the sensor has a center of mass that is supported as second cantilever by the cantilevered probe.

12. The method of claim 9 wherein the sensor responds to acceleration by bending about a hinge.

13. The method of claim 9 wherein the sensor responds to acceleration with torsional movement about a hinge.

14. A method for modifying a probe for scanning a sample with an atomic force microscope, comprising:
providing a cantilevered probe assembly useful for atomic force microscopy, the assembly including a tip and a planar structural member;
cutting a paddle through the plane of the structural member; and
hinging the paddle to the structural member.

15. The method of claim 14 wherein the probe assembly includes a target for reflecting radiation, and said cutting is around the target.

16. The method of claim 14 wherein said hinging is by cutting around hinges in the structural member.

17. The method of claim 14 wherein said cutting is with an ion beam.

18. An apparatus for scanning a sample with a microscope, comprising:
a cantilever beam having two opposing ends, one end being fixed within the microscope and the other end being free, said beam being rotatable in a first direction about the fixed end;
a tip extending from said beam proximate the free end, said tip being adapted and configured for interacting with the sample; and
a paddle coupled to said beam by at least one flexible hinge and rotatable relative to said beam in a second direction about said hinge, the second direction being substantially orthogonal to the first direction;
wherein said beam has a planar surface from the free end to the fixed end, and movement of said paddle about said hinge is substantially normal to the planar surface.

19. The apparatus of claim 18 wherein said beam has a length from the fixed end to the free end, and said paddle is located along the length at a position between the free end and the midpoint of the length.

20. The apparatus of claim 18 wherein said paddle has a center of mass, said hinge permits rotation about a hinge axis, and the center of mass is spaced apart from the hinge axis.

21. The apparatus of claim 18 wherein said paddle has a pair of opposing ends, with one end of said paddle being supported by said hinge and the other end of said paddle being free.

22. The apparatus of claim 18 wherein said beam has two opposing sides, and said paddle is located between the sides.

23. The apparatus of claim 18 wherein said beam is generally rectangular.

24. The apparatus of claim 18 wherein said beam is generally triangular.

25. The apparatus of claim 18 wherein said paddle has a planar surface that is substantially coplanar with the planar surface of said beam.

26. The method of claim 9 wherein said providing includes an electronic controller operably connected to an actuator, the actuator capable of receiving a signal from the controller and moving the sample relative to the probe in response thereto, said measuring is by the controller, and which further comprises moving the sample relative to the probe in response to said measuring.

27. the method of claim 10 wherein the detector is capable of measuring a doppler shift in the frequency content of the radiation, and said measuring is of the doppler shift.

28. The method of claim 10 wherein the detector is capable of measuring an angular relationship between the probe and the sensor, and said measuring is of the relative angle.
